(19) United States
(12) Patent Application Publication
(10) Pub. No.: US 2018/0144364 A1
(43) Pub. Date: May 24, 2018

(54) REAL-WORLD CONVERSION TRACKING SYSTEM

(71) Applicant: CATALINA MARKETING CORPORATION, St. Petersburg, FL (US)

(72) Inventor: Benjamin S. Sprecher, Waban, MA (US)

(21) Appl. No.: 15/819,256

(22) Filed: Nov. 21, 2017

Related U.S. Application Data
(60) Provisional application No. 62/424,836, filed on Nov. 21, 2016.

(51) Int. Cl. G06Q 30/02

(52) U.S. Cl. CPC G06Q 30/0246

(57) ABSTRACT

Methods are provided for accomplishing computer-implemented methods of real-world conversion tracking. The methods include providing an electronic commerce advertisement for at least one product, receiving impression identification information and user identification information for the user, storing the impression identification information and the user identification information in a database, receiving an indication that the at least one product has been purchased by a purchaser at a physical store, identifying purchaser identification information associated with the purchase and received from the purchaser at the physical store, comparing the purchaser identification information for the purchaser with the user identification information for the user to determine whether the purchaser and the user identify a same person, and accordingly providing an indication of whether electronic commerce advertisement for the at least one product was viewed by the user prior to the user purchasing the at least one product in the physical store.

### CROSS-REFERENCE TO RELATED APPLICATIONS

The present application claims the benefit of priority under 35 U.S.C. § 119 from U.S. Provisional Application No. 62/424,836 filed on Nov. 21, 2016, the disclosure of which is hereby incorporated by reference in its entirety for all purposes.

### TECHNICAL FIELD

The present disclosure generally relates to a marketing system, and more specifically relates to a real-world conversion tracking system that analyzes purchases of products in a physical store with respect to exposures to advertisements or other events.

### BACKGROUND

Conventional conversion tracking systems provide tools and methods for comparing and analyzing purchases made through electronic commerce with advertisement impressions to electronic advertisements provided over integrated data networks. Such conversion tracking systems are limited in that they only are able to track the conversions of purchases made via electronic commerce.

### SUMMARY

In certain aspects, the present disclosure provides a computer-implemented method. The method includes providing, for display to a user, an electronic commerce advertisement for at least one product, and the electronic commerce advertisement can include an identification tag, and receiving, in response to the user viewing the electronic commerce advertisement and in accordance with instructions associated with the identification tag, impression identification information and user identification information for the user. The method further includes storing the impression identification information and the user identification information in a database, and the database can be associated with the at least one product, receiving an indication that the at least one product has been purchased by a purchaser at a physical store, and identifying purchaser identification information associated with the purchase and received from the purchaser at the physical store. The method also includes comparing the purchaser identification information for the purchaser with the user identification information for the user to determine whether the purchaser and the user identify a same person, and when the comparison indicates the user identification information and the purchaser identification information identify the same person, then providing an indication that the electronic commerce advertisement for the at least one product was viewed by the user prior to the user purchasing the at least one product in the physical store.

In certain aspects, the present disclosure also provides for a system including a memory. The memory includes instructions. The system further includes one or more processors configured to execute the instructions to provide, for display to a user, an electronic commerce advertisement for at least one product. The electronic commerce advertisement can include an identification tag and receive, in response to the user viewing the electronic commerce advertisement and in accordance with instructions associated with the identification tag, impression identification information for the viewing and the electronic commerce advertisement, and user identification information for the user. The user identification information can be ascertained from electronic tracking technologies within a browser, application or operating system installed on an electronic device on which the electronic commerce advertisement is displayed, or from user financial information, user loyalty membership information, user governmental information and/or user biometric information. The instructions can further command the processors to store the impression identification information and the user identification information in a database, and the database can be associated with the at least one product, receive an indication that the at least one product has been purchased at a physical store by a purchaser and identify purchaser identification information associated with the purchase. The purchaser identification information can be ascertained from purchaser financial information at the time of the purchaser purchasing the product or from membership information provided by the purchaser at the time of the purchaser purchasing the product. The instructions can further command the processor to compare the purchaser identification information for the purchaser with the user identification information for the user to determine whether the purchaser and the user identify a same person, and when the comparison indicates the user identification information and the purchaser identification information identify the same person, then provide an indication that the electronic commerce advertisement for the at least one product was viewed by the user prior to the user purchasing the at least one product in the physical store.

In certain aspects, the present disclosure also provides a non-transitory machine-readable storage medium comprising machine-readable instructions for causing a processor to execute a method. The method can include providing, for display to a user, an electronic commerce advertisement for at least one product, the electronic commerce advertisement can include an identification tag and receiving, in response to the user viewing the electronic commerce advertisement and in accordance with instructions associated with the identification tag, impression identification information and user identification information for the user. The impression identification information can include data regarding a time at which, and an electronic device on which, the electronic commerce advertisement was displayed, and the user identification information can comprise a unique user identifier associated with user financial information, user loyalty membership information, user governmental information, or user biometric information identifying a person or household as the user. The method can further include storing the impression identification information and the user identification information in a database, the database can be associated with the at least one product, receiving an indication that the at least one product has been purchased by a purchaser at a physical store and identifying purchaser identification information associated with the purchase and received from the purchaser at the physical store. The method can further include comparing the purchaser identification information for the purchaser with the user identification information for the user to determine whether the purchaser and the user identify a same person or household, and when the comparison indicates the user identification information and the purchaser identification information identify the same person, then providing an indication that the electronic commerce advertisement for the at least one product was viewed by the user prior to the user purchasing the at least one product in the physical store.

In yet another embodiment, a system is described that includes a means for storing commands and a means for executing the commands causing the system to perform a method. The method includes providing, for display to a user, an electronic commerce advertisement for at least one product, the electronic commerce advertisement comprising an identification tag and receiving, in response to the user viewing the electronic commerce advertisement and in accordance with instructions associated with the identification tag, impression identification information and user identification information for the user. The method also includes storing the impression identification information and the user identification information in a database, the database being associated with the at least one product, receiving an indication that the at least one product has been purchased by a purchaser at a physical store and identifying purchaser identification information associated with the purchase and received from the purchaser at the physical store. The method further includes comparing the purchaser identification information for the purchaser with the user identification information for the user to determine whether the purchaser and the user identify a same person, and when the comparison indicates the user identification information and the purchaser identification information identify the same person, then providing an indication that the electronic commerce advertisement for the at least one product was viewed by the user prior to the user purchasing the at least one product in the physical store.

In certain aspects, a computer-implemented method is disclosed. The computer-implemented method includes providing, for display to a user, a commerce advertisement on a physical medium for at least one product, ascertaining impression identification information and user identification information in response to the user viewing the commerce advertisement and storing the impression identification information and the user identification information in a database, the database being associated with the at least one product. The method further includes receiving an indication that the at least one product has been purchased by a purchaser at a store, identifying purchaser identification information associated with the purchase and received from the purchaser at the store, comparing the purchaser identification information for the purchaser with the user identification information for the user to determine whether the purchaser and the user identify a same person, and when the comparison indicates the user identification information and the purchaser identification information identify the same person, then providing an indication that the commerce advertisement for the at least one product was viewed by the user prior to the user purchasing the at least one product in the store.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an exemplary architecture for accomplishing computer-implemented methods of real-world conversion tracking according to exemplary implementations of the present disclosure.

FIG. 2 is a block diagram illustrating the example servers and clients in the architecture of FIG. 1 according to exemplary aspects of the present disclosure.

FIG. 3 sets forth a process for accomplishing computer-implemented methods of real-world conversion tracking according to exemplary aspects of the present disclosure.

FIG. 4 is a block diagram illustrating an exemplary computer system with which the example clients and server of FIG. 2 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### General Overview

Businesses place great value on determining the efficacy of various forms of marketing. A successful marketing strategy can greatly enhance the performance of a certain product, while a poor marketing strategy can hinder product sales. However, a technical problem exists in this space, namely, there is currently no way to ascertain the value of electronic commerce advertisement campaigns when subsequent purchases are made offline at physical stores. This is because there is no current technically implemented system for tracking a user from a time when the user views an electronic advertisement until the time a purchase of a product related to the electronic advertisement is made in a physical store. The current disclosure provides a technical solution to this technical problem, namely, a system for recording that a user has viewed such an advertisement, gathering identifying information of the user and, when a purchase of a relevant product is made in a physical store, gathering purchaser information. The disclosure also provides for comparing the user's identifying information with the purchaser's information to learn whether the user who was exposed to the electronic advertisement also purchased the relevant product in a physical store. The information provided by this technical solution is highly valuable in gauging the efficacy of various forms of electronic advertisements. It is also applicable to tracking and measuring the efficacy of other Exposure Events that are not, strictly speaking, electronic advertisements—such as an individual receiving direct mail or an ad in a magazine or when they drive by a billboard—each of these events can be tracked and measured back to its impact on in-store sales in a physical store in much the same way as eCommerce merchants can track the sales effect of an online ad to the associated sales that ad drives in the online store.

Although certain examples provided herein may describe a user's, or recipient's, information being stored in memory, each user and/or recipient must grant explicit permission for such information to be stored in some implementations of the present disclosure. The explicit permission may be granted using privacy controls integrated into the disclosed system. Each user and/or recipient can be provided notice that such information will be stored with such explicit consent, and each user or recipient may at any time end having the information stored, and may delete the stored information. The stored information may be encrypted to protect user or recipient security.

The user or recipient can at any time delete the information from memory and/or opt out of having the user or recipient information stored in memory. Additionally, the user or recipient can, at any time, adjust appropriate privacy settings to selectively limit the types of information stored in memory, or select the memory in which the information is stored (e.g., locally on the user's or recipient's device as opposed to remotely a server). In many examples, the information does not include and/or share the specific identification of the user or recipient (e.g., the user's or recipient's name) unless otherwise specifically provided or directed by the user or recipient.

The disclosed system addresses the technical problem of real-world conversion tracking according to exemplary implementations, specifically arising in the realm of computer and network technology. Electronic commerce and user tracking are inherently computer-related fields. Further, the very large amount of electronic commerce advertisements, and thus users exposed thereto, requires large amounts of electronic processing power and storage, again requiring the use of computer and network technology. Also, absent the present disclosure, to track conversions between online commerce advertisements and purchases made in physical stores, a user has to identify himself or herself by bring the electronic device, on which the advertisement was displayed, to the store and conveying impression information to the server. This requires excessive, and inefficient, processing power from the electronic device, as well as user inconveniences and the potential for lost conversion data when the electronic device is not brought to the store. Finally, as listed below, the current disclosure addresses a technical problem as a technical solution is required therefore, as described below.

The current disclosure provides a technical solution to the above-mentioned problem, also rooted in computer technology, namely, by electronically tracking user information, electronically gathering impression information, electronically ascertaining purchaser information, electronically conveying all data to a server over a network, and electronically comparing data within the database by a computer. Each of these facets clearly involves a technical solution rooted in computer technology.

### Example System Architecture

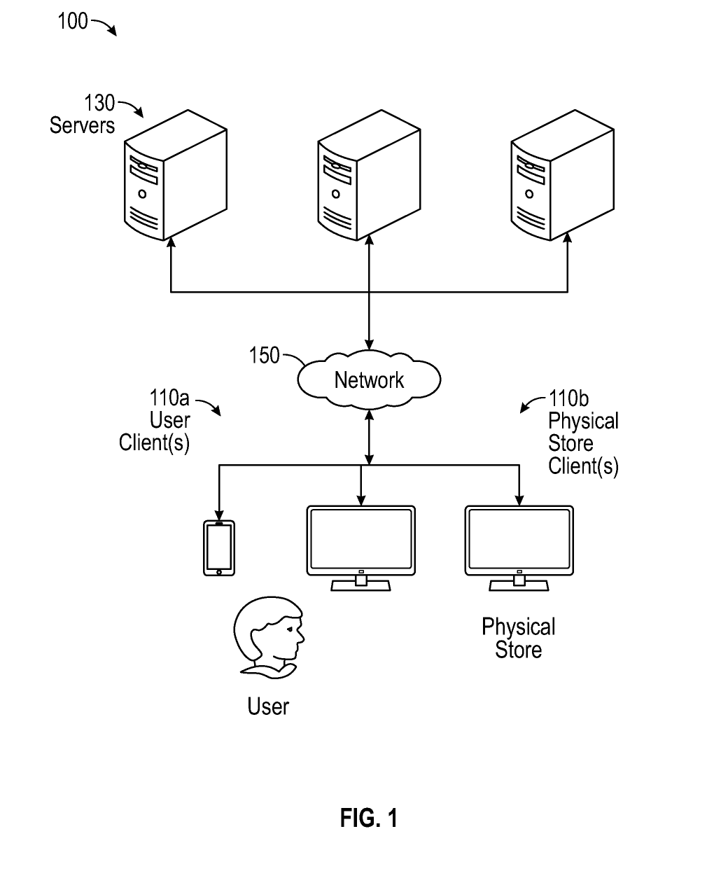

FIG. 1 illustrates an exemplary architecture 100 for accomplishing computer-implemented methods of real-world conversion tracking according to exemplary implementations of the present disclosure. The architecture 100 includes one or more servers 130 and one or more user clients 110a and physical store clients 110b connected over a network 150. One of the servers 130 can be configured to host a system for accomplishing computer-implemented methods of real-world conversion tracking between the user clients 110a and physical store clients 110b over the network 150. For purposes of load balancing, multiple servers 130 can host the architecture 100 for the system for accomplishing computer-implemented methods of real-world conversion tracking between the user clients 110a and physical store clients 110b over the network 150 suitable for practicing some implementations of the present disclosure.

The servers 130 can be any device having an appropriate processor, memory, and communications capability for accomplishing computer-implemented methods of real-world conversion tracking between the user clients 110a and physical store clients 110b over the network 150. The user clients 110a and physical store clients 110b to which the servers 130 are connected over the network 150 can be, for example, any communication device such as desktop computers, mobile computers, tablet computers (e.g., including e-book readers), mobile devices (e.g., a smartphone or PDA), set top boxes (e.g., for a television), video game consoles, cash registers, bar-code scanners, QR code scanners, biometric sensors, optical sensors, acoustic sensors, fingerprint sensors, facial recognition sensors or any other devices having appropriate processor, memory, and communications capabilities. In certain aspects, one or more of the servers 130 can be a cloud computing server of an infrastructure-as-a-service (IaaS) and be able to support a platform-as-a-service (PaaS) and software-as-a-service (SaaS) services.

The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

### Exemplary System for Accomplishing Computer-Implemented Methods of Real-World Conversion Tracking

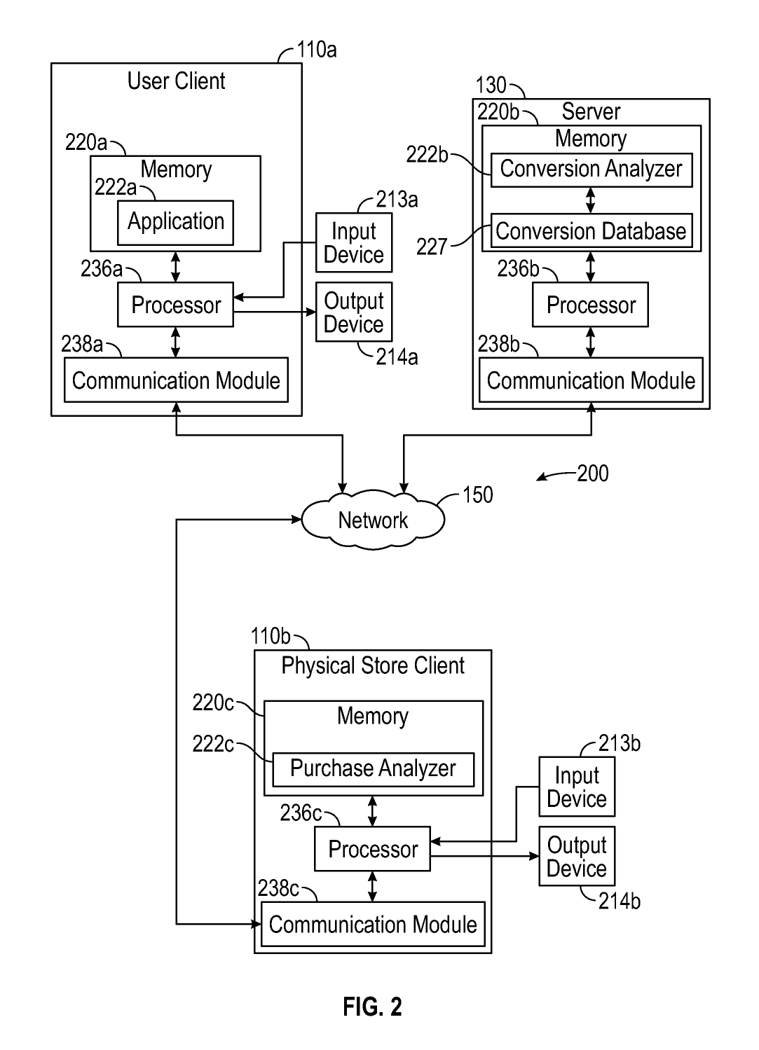

FIG. 2 is a block diagram 200 illustrating an exemplary server 130, a user client 110a and a physical store client 110b in the architecture 100 of FIG. 1 according to certain aspects of the disclosure. The user client 110a, physical store client 110b and server 130 are connected over the network 150 via their respective communications modules 238a, 238c and 238b. The communications modules 238a, 238b and 238c are configured to interface with the network 150 to send and receive information, such as data, requests, responses, and commands to other devices on the network 150. The communications modules 238a, 238b and 238c can be, for example, modems or Ethernet cards.

The server 130 includes a processor 236b, a communications module 238b and a memory 220b. The memory 220b of the server 130 includes a conversion analyzer 222b and a conversion database 227. The processor 236b of the server 130 is configured to execute instructions, such as instructions physically coded into the processor 236b, instructions received from software in memory 220b, or a combination of both.

The user client 110a and physical store client 110b include processors 236a, 236c, communications modules 238a, 238c, and memories 220a, 220c. Memory 220a includes application 222a, and memory 220c includes purchase analyzer 222c. The application 222a can be an operating system, software application, firmware or other operable and/or device-installed instruction program, and can ascertain, store and/or convey impression identification information or user identification information. The purchase analyzer 222c can be an operating system, software application, firmware or other operable and/or device-installed instruction program used for analyzing details of a purchased product, of a transaction or of purchaser identification information. The conversion analyzer 222b can be an operating system, software application, firmware or other operable and/or device-installed instruction program used to compare impression identification information, user identification information, purchaser identification information and/or details of a purchased product. Each of the application 222a, purchase analyzer 222c, conversion analyzer 222b and conversion database 227 can communicate with each other via the network 150 and/or respective communication modules 238a, 238c and 238b.

The user client 110a and the physical store client 110b also each include an input device 213a and 213b, such as a keyboard, touchscreen, microphone, cash register, UPC scanner, QR scanner, biometric sensor, trackball and/or mouse, and an output device 214a and 214b, such as a display and/or audio speaker. The processors 236a, 236c of the clients 110a, 110b are configured to execute instructions, such as instructions physically coded into the processors 236a, 236c, and/or instructions received from software (e.g. application 222a, purchase analyzer 222c and/or conversion analyzer 222b) in memories 220a, 220b, 220c, or a combination of both. For example, instructions from the application 222a, purchase analyzer 222c and/or conversion analyzer 222b may be a module executed by the processors 236a, 236b, 236c to receive a plurality of communication logs related to the communication.

In some implementations, the present disclosure provides a system 200 for accomplishing computer-implemented methods of real-world conversion tracking. The system 200 can include a memory having instructions and one or more processors 236a, 236b, 236c.

The processors 236a, 236b, 236c can be configured to execute instructions to provide, for display to a user, an electronic commerce advertisement for at least one product, and the electronic commerce advertisement can include an identification tag. The electronic commerce advertisement can be disposed on an electronic device, which may be a mobile device, a computer or any other electronic communication device known to those skilled in the art. The advertisement can be, for example, a video advertisement for a food product, displayed as a Graphics Interchange Format (GIF) file in a banner format on a web page loaded on a smartphone which the user operates. Thus, the user is exposed to the GIF file for the food product on the web page loaded on the smartphone. The electronic commerce advertisement can include one or more of video content, still image content and audio content.

The processors 236a, 236b, 236c can be configured to execute instructions to receive, in response to the user viewing the electronic commerce advertisement and in accordance with instructions associated with the identification tag, impression identification information and user identification information for the user. In some examples, the identification tag includes a script embedded in a web page on which the electronic commerce advertisement is displayed. The script can draw a unique image, or produce unique code, invisible to the user that is then trackable to identify a history of that user or device. The impression identification can indicate that the electronic commerce advertisement was viewed at 3:00 p.m. on a particular IPHONE smartphone, and the user identification information can include, for example, an email address. The email address can be entered by the user, or previously used within a browser or application on the IPHONE smartphone. Further, the electronic device on which the electronic commerce advertisement is displayed can be a smartphone, tablet or personal computer. Other devices and technologies, for example those utilizing augmented reality and virtual reality, can also display elements of the electronic commerce advertisement. For example, the user enters personal information, financial information, governmental information or other personal identifying on a web page on a browser on a user's smartphone, which is recorded due to the identification tag, pixel and/or cookies, or other identifying information, on the electronic device. This user identification information is electronically communicated to the server 130 via internet, cellular or another form of wired or wireless communications. The impression identification information and user identification is recorded in the conversion database 227.

The processors 236a, 236b, 236c can be configured to store the impression identification information and the user identification information in a database, and the database can be associated with the at least one product. For example, the database can record some or all user identification information and/or impression identification information corresponding with users exposed to the electronic commerce advertisement impression in a particular timeframe.

The processors 236a, 236b, 236c can be configured to receive an indication that the at least one product has been purchased by a purchaser at a physical store. In an example, a UPC scanner at the physical store scans a UPC bar code of a single serving beverage, such as a COCA-COLA. The physical store, or physical store client 110b, electronically communicates with processors 236a, 236b, 236c, via internet, cellular or another form of wired or wireless communications, and indicates to the processors 236a, 236b, 236c, and/or server 130, that the single serving beverage has been purchased at the physical store.

The processors 236a, 236b, 236c can be configured to identify purchaser identification information associated with the purchase and received from the purchaser at the physical store. For example, during a purchase at the physical store, the purchaser enters loyalty card number 123456789 at the physical store, and this is electronically communicated to the server 130 via internet, cellular or another form of wired or wireless communications when the COCA-COLA is purchased.

The processors 236a, 236b, 236c can be configured to compare the purchaser identification information for the purchaser with the user identification information for the user to determine whether the purchaser and the user identify a same person. When the comparison indicates the user identification information and the purchaser identification information identify the same person, then the system 200 can provide an indication that the electronic commerce advertisement for the at least one product was viewed by the user prior to the user purchasing the at least one product in the physical store. For example, the processors 236a, 236b, 236c search within the conversion database 227 and ascertain that the user identification information recorded by the identification tag, pixel or cookies, and the loyalty number 123456789 entered by the purchaser at the physical store, indicate common identifying data within the conversion database 227. The processors 236a, 236b, 236c thus identify the user and the purchaser as the same individual.

The processors 236a, 236b, 236c can also be configured to ascertain the user identification information from electronic tracking technologies within a browser, application, or operating system installed on an electronic device on which the electronic commerce advertisement is displayed, and/or from one or more sources comprising user financial information, user loyalty membership information, user governmental information, or user biometric information. For example, user loyalty membership information can be entered by a user on a web page on the browser, previously entered by a user in the web page in the browser or deduced from user purchase, financial or membership histories. In some examples, governmental information, biometric information or financial information can be entered by a user on the web page on the browser, previously entered by a user in the web page in the browser, deduced from user purchase financial or membership histories or ascertained by other sensors, such as a fingerprint or optical sensor, on the electronic device, which can be an IPHONE smartphone.

The impression identification information can include data regarding the time the electronic commerce advertisement was displayed to the user, or a geographic location in which the electronic commerce advertisement was displayed to the user. Further, the impression identification information can include data regarding an electronic device on which the electronic commerce advertisement was displayed. The product can be identified as being associated with the database via a universal product code of the product.

The processors 236a, 236b, 236c can also be configured to ascertain the purchaser identification information from user financial information at the time of the purchaser purchasing the product, from membership information provided by the purchaser at the time of the purchaser purchasing the product, and/or from personal contact information provided by the purchaser at the time of purchasing the product. For example, purchaser identification information can be entered by a user at the time of purchase at a cash register or other input device, or deduced from user purchase, financial or membership histories, governmental information or from biometric information. In some examples, biometric information can be ascertained by sensors, such as a fingerprint or optical sensor, at the time of purchase on a cash register or other input device. In another example, financial information deduced from an electronic payment form, such as a credit card, can provide identifying purchaser information. In some examples, the processors 236a, 236b, 236c and/or server 130 contact a credit bureau to ascertain purchaser identification information after the purchase has been made in order to attempt to identify the user. In another example, specific purchases can provide identifying purchaser information.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

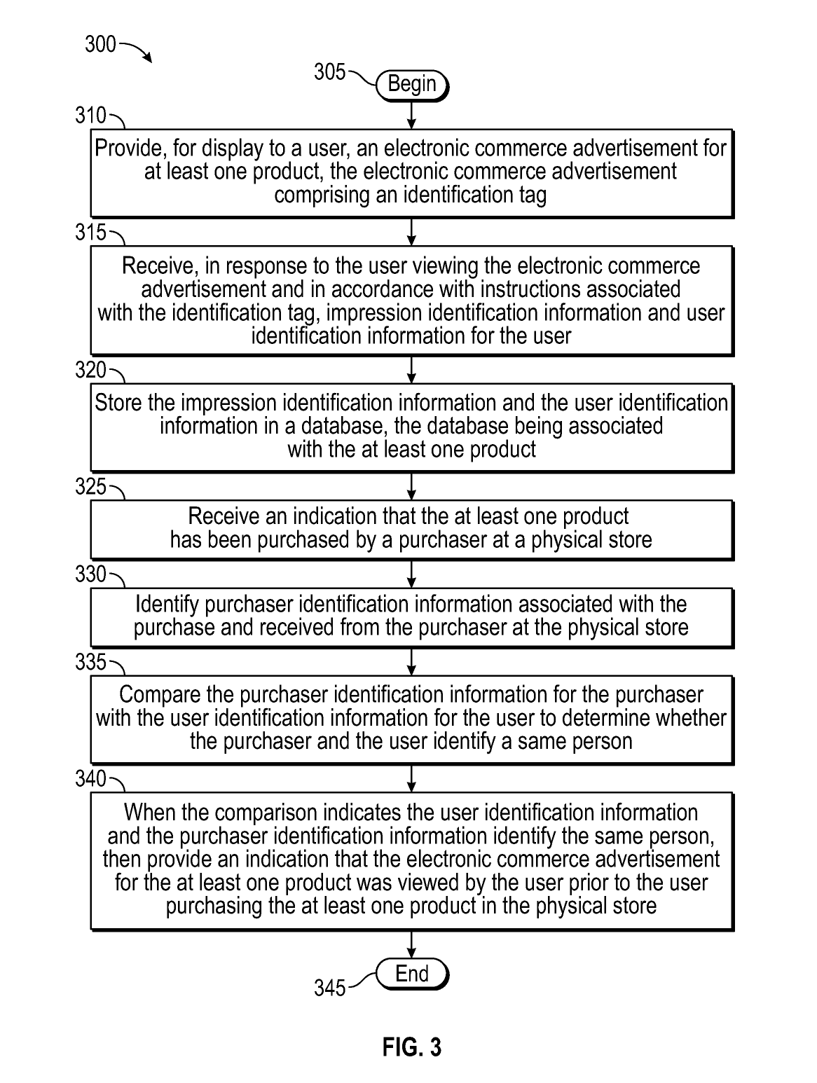

FIG. 3 illustrates an exemplary process 300 for accomplishing computer-implemented methods of real-world conversion tracking using the example system of FIG. 2. While FIG. 3 is described with reference to FIG. 2, it should be noted that the process steps of FIG. 3 may be performed by other systems. The process 300 begins by proceeding from step 305 to step 310 by providing, for display to a user, an electronic commerce advertisement for at least one product, the electronic commerce advertisement including an identification tag. In step 315, the method includes receiving, in response to the user viewing the electronic commerce advertisement and in accordance with instructions associated with the identification tag, impression identification information and user identification information for the user. In step 320, the method includes storing the impression identification information and the user identification information in a database, the database being associated with the at least one product. In step 325, the method includes receiving an indication that the at least one product has been purchased by a purchaser at a physical store.

The process 300 continues with step 330, which includes identifying purchaser identification information associated with the purchase and received from the purchaser at the physical store. In step 335, the method includes comparing the purchaser identification information for the purchaser with the user identification information for the user to determine whether the purchaser and the user identify a same person or household. Further, such a determination can be accomplished through onboarders and ID match schemes. In step 340, when the comparison indicates the user identification information and the purchaser identification information identify the same person, the method includes providing an indication that the electronic commerce advertisement for the at least one product was viewed by the user prior to the user purchasing the at least one product in the physical store. The process 300 ends at step 345.

The process 300 begins by proceeding from step 305 to step 310 by providing, for display to a user, a video advertisement for a single serving COCA-COLA on a web page on a browser of the user's smartphone. The COCA-COLA video advertisement includes a tracking pixel and the user is assigned a user identification number tracked by the tracking pixel. In step 315, the method includes receiving, by a server via internet communication channels, in response to the user viewing the COCA-COLA video advertisement and in accordance with the user identification tracking number and instructions associated with the tracking pixel, a communication indicating the COCA-COLA video advertisement was viewed at 3:00 pm on Jul. 18, 2017 on an PHONE smartphone, as well as a self-identifying email address, or anonymized person or household identifier, previously entered on a web page by the user and associated with the user. In step 320, the method includes storing the device and time data and the advertisement information (3:00 pm on Jul. 18, 2017, on an IPHONE smartphone, and the self-identifying email address) in a conversion database, and the conversion database is associated with the single serving COCA-COLA. In step 325, the method includes receiving an indication that the single serving COCA-COLA has been purchased by a purchaser at a physical store.

In step 330, when the user goes to a physical store and purchases the single serving COCA-COLA, a UPC scanner at the physical store scans a UPC bar code of the single serving COCA-COLA. The physical store, or a physical store client, electronically communicates with the server 130 via internet, cellular or another form of wired or wireless communications, and indicates to the server that the single serving COCA-COLA has been purchased at the physical store.

Upon purchasing the single serving COCA-COLA, the user, or purchaser, enters loyalty card number 123456789 on a purchaser input device at the physical store, such as a card-swiping device. This loyalty card number is electronically communicated to the server and database via internet, cellular or another form of wired or wireless communications when the single serving COCA-COLA is purchased.

In step 335, processors search within the database and determine that the self-identifying email address and the loyalty card number 123456789 entered by the purchaser at the physical store indicate common identity based on information associated with the self-identifying email address and information associated with the loyalty card number. Thus, in step 340, the user and the purchaser are identified as the same individual. The process 300 ends at step 345.

Additionally, a method for accomplishing computer-implemented methods of real-world conversion tracking according to exemplary implementations of the present disclosure is described below, in particular describing a method involving non-digital advertising. The method includes providing, for display to a user, a commerce advertisement on a physical medium for at least one product. The physical medium can include a billboard, postcard, magazine advertisement, newspaper advertisement or any other physical medium capable of displaying a non-digital advertisement.

The method further includes ascertaining impression identification information and user identification information in response to the user viewing the commerce advertisement. User identification information can include physical address information, with regard to physically-mailed items such as postcards, magazines and newspapers. User identification information can also be deduced from geo-tracking, whereby a user's location, tracked by Global Positioning Systems or GLONASS on a mobile device, physical addresses or other geographic identifier, is analyzed in relation to the physical medium on which the commerce advertisement is displayed. For example, a user's location, based on GPS data from their mobile device, is tracked as the user passes a billboard while driving on a road.

User identification information can also be ascertained by an affirmative action taken by the user upon being exposed to the advertisement, such as texting a specific code or phrase to a recipient, as instructed on the advertisement. It is to be understood that all methods of non-digital, as well as digital, advertisements are within the scope of the current disclosure in the context of advertisement impressions. Further, throughout this disclosure, the exposure of a user to any form of advertisement on any medium can be referred to as an “exposure event” and the purchase of a product related to the advertisement by the user can be referred to as a “purchase event.” To avoid duplication, the remainder of the method is similar to the above examples, and a description thereof will be omitted.

### Hardware Overview

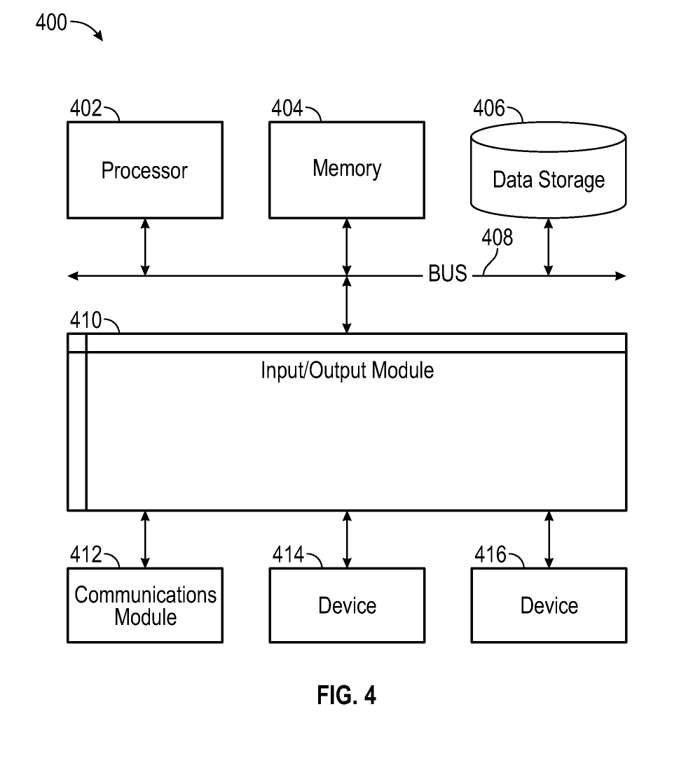

FIG. 4 is a block diagram illustrating an example computer system 400 with which clients 110a and 110b and server 130 of FIG. 2 can be implemented. In certain aspects, the computer system 400 may be implemented using hardware or a combination of software and hardware, either in a dedicated server, or integrated into another entity, or distributed across multiple entities.

Computer system 400 (e.g., clients 110a, 110b, 110c and server 130) includes a bus 408 or other communication mechanism for communicating information, and a processor 402 (e.g., processor 236a, 236b, 236c) coupled with bus 408 for processing information. According to one aspect, the computer system 400 can be a cloud computing server of an IaaS that is able to support PaaS and SaaS services. According to one aspect, the computer system 400 is implemented as one or more special-purpose computing devices. The special-purpose computing device may be hard-wired to perform the disclosed techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. By way of example, the computer system 400 may be implemented with one or more processors 402. Processor 402 may be a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

Computer system 400 can include, in addition to hardware, code that creates an execution environment for the computer program in question, e.g., code that constitutes processor firmware, a protocol stack, a database management system, an operating system, or a combination of one or more of them stored in an included memory 404 (e.g., memory 220a, 220b, 220), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 408 for storing information and instructions to be executed by processor 402. The processor 402 and the memory 404 can be supplemented by, or incorporated in, special purpose logic circuitry. Expansion memory may also be provided and connected to computer system 400 through input/output module 410, which may include, for example, a SIMM (Single In Line Memory Module) card interface. Such expansion memory may provide extra storage space for computer system 400, or may also store applications or other information for computer system 400. Specifically, expansion memory may include instructions to carry out or supplement the processes described above, and may include secure information also. Thus, for example, expansion memory may be provided as a security module for computer system 400, and may be programmed with instructions that permit secure use of computer system 400. In addition, secure applications may be provided via the SIMM cards, along with additional information, such as placing identifying information on the SIMM card in a non-hackable manner.

The instructions may be stored in the memory 404 and implemented in one or more computer program products, e.g., one or more modules of computer program instructions encoded on a computer readable medium for execution by, or to control the operation of, the computer system 400, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 404 may also be used for storing temporary variable or other intermediate information during execution of instructions to be executed by processor 402.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 400 further includes a data storage device 406 such as a magnetic disk or optical disk, coupled to bus 408 for storing information and instructions. Computer system 400 may be coupled via input/output module 410 to various devices. The input/output module 410 can be any input/output module. Example input/output modules 410 include data ports such as USB ports. In addition, input/output module 410 may be provided in communication with processor 402, so as to enable near area communication of computer system 400 with other devices. The input/output module 410 may provide, for example, for wired communication in some implementations, or for wireless communication in other implementations, and multiple interfaces may also be used. The input/output module 410 is configured to connect to a communications module 412. Example communications modules 412 (e.g., 238a, 238b and 238c) include networking interface cards, such as Ethernet cards and modems.

The components of the system can be interconnected by any form or medium of digital data communication, e.g., a communication network. The communication network (e.g., communication network 150) can include, for example, any one or more of a PAN,a (LAN), a CAN, a MAN, a (WAN, a BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

For example, in certain aspects, communications module 412 can provide a two-way data communication coupling to a network link that is connected to a local network. Wireless links and wireless communication may also be implemented. Wireless communication may be provided under various modes or protocols, such as GSM (Global System for Mobile Communications), Short Message Service (SMS), Enhanced Messaging Service (EMS), or Multimedia Messaging Service (MMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), among others. Such communication may occur, for example, through a radio-frequency transceiver. In addition, short-range communication may occur, such as using a BLUETOOTH, WI-FI, or other such transceiver.

In any such implementation, communications module 412 sends and receives electrical, electromagnetic or optical signals that carry digital data streams representing various types of information. The network link typically provides data communication through one or more networks to other data devices. For example, the network link of the communications module 412 may provide a connection through local network to a host computer or to data equipment operated by an Internet Service Provider (ISP). The ISP in turn provides data communication services through the world wide packet data communication network now commonly referred to as the “Internet”. The local network and Internet both use electrical, electromagnetic or optical signals that carry digital data streams. The signals through the various networks and the signals on the network link and through communications module 412, which carry the digital data to and from computer system 400, are example forms of transmission media.

Computer system 400 can send messages and receive data, including program code, through the network(s), the network link and communications module 412. In the Internet example, a server might transmit a requested code for an application program through Internet, the ISP, the local network and communications module 412. The received code may be executed by processor 402 as it is received, and/or stored in data storage 406 for later execution.

In certain aspects, the input/output module 410 is configured to connect to a plurality of devices, such as an input device 414 and/or an output device 416. Example input devices 414 include a keyboard and a pointing device, e.g., a mouse or a trackball, by which a user can provide input to the computer system 400. Other kinds of input devices 414 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 416 include display devices, such as a LED (light emitting diode), CRT (cathode ray tube), LCD (liquid crystal display) screen, a TFT LCD (Thin-Film-Transistor Liquid Crystal Display) or an OLED (Organic Light Emitting Diode) display, for displaying information to the user. The output device 416 may include appropriate circuitry for driving the output device 416 to present graphical and other information to a user.

According to one aspect of the present disclosure, the clients 110a and 110b and server 130 can be implemented using a computer system 400 in response to processor 402 executing one or more sequences of one or more instructions contained in memory 404. Such instructions may be read into memory 404 from another machine-readable medium, such as data storage device 406. Execution of the sequences of instructions contained in main memory 404 causes processor 402 to perform the process steps described herein. One or more processors in a multi-processing arrangement may also be employed to execute the sequences of instructions contained in memory 404. Processor 402 may process the executable instructions and/or data structures by remotely accessing the computer program product, for example by downloading the executable instructions and/or data structures from a remote server through communications module 412 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

Computer system 400 can include clients and servers. A client and server are generally remote from each other and typically interact through a communication network. The relationship of client and server arises by virtue of computer programs running on the respective computers and having a client-server relationship to each other. Computer system [#6]00 can be, for example, and without limitation, a desktop computer, laptop computer, or tablet computer. Computer system 400 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer-readable medium” as used herein refers to any medium or media that participates in providing instructions or data to processor 402 for execution. The term “storage medium” as used herein refers to any non-transitory media that store data and/or instructions that cause a machine to operate in a specific fashion. Such a medium may take many forms, including, but not limited to, non-volatile media, volatile media, and transmission media. Non-volatile media include, for example, optical disks, magnetic disks, or flash memory, such as data storage device 406. Volatile media include dynamic memory, such as memory 404. Transmission media include coaxial cables, copper wire, and fiber optics, including the wires that include the bus 408. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that include bus 408. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method, comprising:
providing, for display to a user, an electronic commerce advertisement for at least one product, the electronic commerce advertisement comprising an identification tag;
receiving, in response to the user viewing the electronic commerce advertisement and in accordance with instructions associated with the identification tag, impression identification information and user identification information for the user;
storing the impression identification information and the user identification information in a database, the database being associated with the at least one product;
receiving an indication that the at least one product has been purchased by a purchaser at a physical store;
identifying purchaser identification information associated with the purchase and received from the purchaser at the physical store;
comparing the purchaser identification information for the purchaser with the user identification information for the user to determine whether the purchaser and the user identify a same person; and
when the comparison indicates the user identification information and the purchaser identification information identify the same person, then providing an indication that the electronic commerce advertisement for the at least one product was viewed by the user prior to the user purchasing the at least one product in the physical store.

2. The method of claim 1, wherein the user identification information is ascertained from electronic tracking technologies within a browser, application, or operating system installed on an electronic device on which the electronic commerce advertisement is displayed.

3. The method of claim 1, wherein the user identification information is ascertained from one or more sources comprising user financial information, user loyalty membership information, user governmental information, or user biometric information.

4. The method of claim 1, wherein the impression identification information comprises data regarding the time the electronic commerce advertisement was displayed to the user, or a geographic location in which the electronic commerce advertisement was displayed to the user.

5. The method of claim 1, wherein the impression identification information comprises data regarding an electronic device on which the electronic commerce advertisement was displayed.

6. The method of claim 1, wherein the product is identified as being associated with the database via a universal product code of the product.

7. The method of claim 1, wherein the purchaser identification information is ascertained from user financial information at the time of the purchaser purchasing the product.

8. The method of claim 1, wherein the purchaser identification information is ascertained from membership information provided by the purchaser at the time of the purchaser purchasing the product.

9. The method of claim 1, wherein the purchaser identification information is ascertained from personal contact information provided by the purchaser at the time of purchasing the product.

10. The method of claim 1, wherein the electronic commerce advertisement comprises video content.

11. The method of claim 1, wherein the electronic commerce advertisement comprises still image content.

12. The method of claim 1, wherein the electronic commerce advertisement comprises audio content.

13. The method of claim 1, wherein an electronic device on which the electronic commerce advertisement is displayed is a smartphone.

14. A system, comprising:
a memory comprising instructions;
one or more processors configured to execute the instructions to:
provide, for display to a user, an electronic commerce advertisement for at least one product, the electronic commerce advertisement comprising an identification tag;
receive, in response to the user viewing the electronic commerce advertisement and in accordance with instructions associated with the identification tag, impression identification information for the viewing and the electronic commerce advertisement, and user identification information for the user, the user identification information being ascertained from electronic tracking technologies within a browser, application or operating system installed on an electronic device on which the electronic commerce advertisement is displayed, or from user financial information, user loyalty membership information, user governmental information and user biometric information;
store the impression identification information and the user identification information in a database, the database being associated with the at least one product;
receive an indication that the at least one product has been purchased at a physical store by a purchaser;
identify purchaser identification information associated with the purchase, the purchaser identification information being ascertained from purchaser financial information at the time of the purchaser purchasing the product or from membership information provided by the purchaser at the time of the purchaser purchasing the product;
compare the purchaser identification information for the purchaser with the user identification information for the user to determine whether the purchaser and the user identify a same person; and
when the comparison indicates the user identification information and the purchaser identification information identify the same person, then provide an indication that the electronic commerce advertisement for the at least one product was viewed by the user prior to the user purchasing the at least one product in the physical store.

15. The system of claim 14, wherein the impression identification information comprises data regarding a geographic location in which the electronic commerce advertisement was displayed to the user.

16. The system of claim 14, wherein the product is identified as being associated with the database via a universal product code of the product.

17. The system of claim 14, wherein the purchaser identification information is ascertained from personal contact information provided by the purchaser at the time of purchasing the product.

18. The system of claim 14, wherein an electronic device on which the electronic commerce advertisement is displayed is a smartphone.

19. The system of claim 14, wherein the impression identification information comprises data regarding an electronic device on which the electronic commerce advertisement was displayed.

20. A computer-implemented method, comprising:
providing, for display to a user, a commerce advertisement on a physical medium for at least one product;
ascertaining impression identification information and user identification information in response to the user viewing the commerce advertisement;
storing the impression identification information and the user identification information in a database, the database being associated with the at least one product;
receiving an indication that the at least one product has been purchased by a purchaser at a store;
identifying purchaser identification information associated with the purchase and received from the purchaser at the store;
comparing the purchaser identification information for the purchaser with the user identification information for the user to determine whether the purchaser and the user identify a same person; and
when the comparison indicates the user identification information and the purchaser identification information identify the same person, then providing an indication that the commerce advertisement for the at least one product was viewed by the user prior to the user purchasing the at least one product in the store.
